(19) United States
(12) Patent Application Publication
(10) Pub. No.: US 2006/0018118 A1
(43) Pub. Date: Jan. 26, 2006

(54) Spectrum matching

(76) Inventors: Joon Chok Lee, Kuching (MY); Kee Yean Ng, Penang (MY); Heng Yow Cheng, Penang (MY)

Correspondence Address: AGILENT TECHNOLOGIES, INC.;Intellectual Property Administration, Legal Department, DL429, P.O. Box 7599, Loveland, CO, 80537-0599, US

(21) Appl. No.: 10/896,255

(22) Filed: Jul. 21, 2004

(51) Int. Cl. F21V 9/00

(52) U.S. Cl. 362/231

(57) ABSTRACT

Light is generated in accordance with a desired spectral power distribution curve. A spectrum of light is generated with a plurality of different light sources. An optical measurement device measures the spectrum of light generated by the plurality of different light sources. The optical measurement device is able to detect light within the entire spectrum of light generated by the plurality of different light sources. The measured spectrum of light is used as feedback to vary the spectrum of light generated with the plurality of different light sources to approximate the desired spectral power distribution curve.

### BACKGROUND

The sun is the dominant source of light for all living things on earth. Additional currently available sources of light include fire, incandescent lamps, fluorescent lamps, solid-state light emitting devices and so on. Light sources other than the sun are often referred to as artificial light sources. Artificial light sources are sometimes considered deficient in one form or another compared to sunlight.

For many applications, sunlight is the preferred light source. This can be, for example, because sunlight is better able to show true colors for objects of interest, such as paintings, fabric, ink, paper, cotton and so on. Additionally, sunlight can benefit health. For example, in cases of vitamin D deficiency and jaundice, sunlight exposure is recommended. In addition, recent medical findings have shown that the human body heals faster when exposed to sunlight in general and to specific light colors in particular.

However, in many applications, a particular place and/or time make it unfeasible to use sunlight as a light source. Therefore, it is desirable to make available an artificial light source that approximates the same light composition as sunlight.

Commission Internationale de l'Eclairage (CIE) standard illuminant D65 has been recommended to represent average daylight with a color temperature of 6500 Kelvin. The spectral power distribution (SPD) for CIE standard illuminant D65 is very wide ranging from ultraviolet (UV) to infrared (IR) and includes all wavelengths of the visible spectrum in relatively equal amounts.

A typical SPD of an incandescent lamp is mostly in the red and IR range. When incandescent lamps are used as an artificial light source to approximate sunlight, the resulting light has a high color rendering index (CRI). However, since the SPD of incandescent lights is lower at lower light wavelengths, incandescent lamps do not render blues very well. Additionally, incandescent lamps typically have relatively low power efficiency and a short lifetime in the range of 1,000 hours.

A typical SPD of a fluorescent lamp exhibits sharp and narrow spikes corresponding to the type of phosphor used in the lighting lamp. Typically red, green and blue phosphors are used when fluorescent lamps are used as an artificial light source to approximate sunlight. Fluorescent lamps have moderate to high CRI at blue and green regions but low CRI at yellow and red regions. Typical fluorescent lamps have moderate lifetimes in the range of 10,000 hours.

Even though both incandescent and fluorescent lamps can generate lights of different color temperature or SPD, a single incandescent or fluorescent lamp can only generate light source with a single and fixed SPD curve.

In an LED based light source system, different SPD curves can be achieved by adjusting the amount of light output from LED of different colors. LED light sources have high CRI if a substantial number of LEDs of different colors are used. Also, LED based light source systems typically have much longer operating lifetimes than incandescent or fluorescent lamps. Further, LED based light source systems are generally more power efficient than incandescent based light systems.

The optical performance of LEDs can vary with temperature, drive current and aging. LED characteristics also vary from batch to batch for the same fabrication process. Drift of LEDs optical characteristics during operation is not acceptable for many applications because the drift can affect color consistency. Therefore there is a need to control and maintain color consistency dynamically. U.S. Pat. No. 6,344,641 B1, U.S. Pat. No. 6,448,550 B1 and U.S. Pat. No. 6,507,159 B2 provide examples of the management of feedback systems used to protect against drift in LED light systems.

### SUMMARY OF THE INVENTION

In accordance with an embodiment of the present invention, light is generated in accordance with a desired spectral power distribution curve. A spectrum of light is generated with a plurality of different light sources. An optical measurement device measures the spectrum of light generated by the plurality of different light sources. The optical measurement device is able to detect light within the entire spectrum of light generated by the plurality of different light sources. The measured spectrum of light is used as feedback to vary the spectrum of light generated with the plurality of different light sources to approximate the desired spectral power distribution curve.

### BRIEF DESCRIPTION OF THE DRAWINGS

FIG. 1 is a simplified block diagram of a light source in accordance with an embodiment of the present invention.

FIG. 2 shows an SPD curve that represent sunlight as well as additional individual SPD curve that each measure color output of a color LED within the light source shown in FIG. 1.

FIG. 3 shows an SPD curve that represent sunlight as well as an additional SPD curve that represents the light source shown in FIG. 1.

FIG. 4 is a simplified block diagram of a light source in accordance with another embodiment of the present invention.

FIG. 5 is a simplified block diagram of an optical measurement device in accordance with an embodiment of the present invention.

### DESCRIPTION OF THE EMBODIMENT

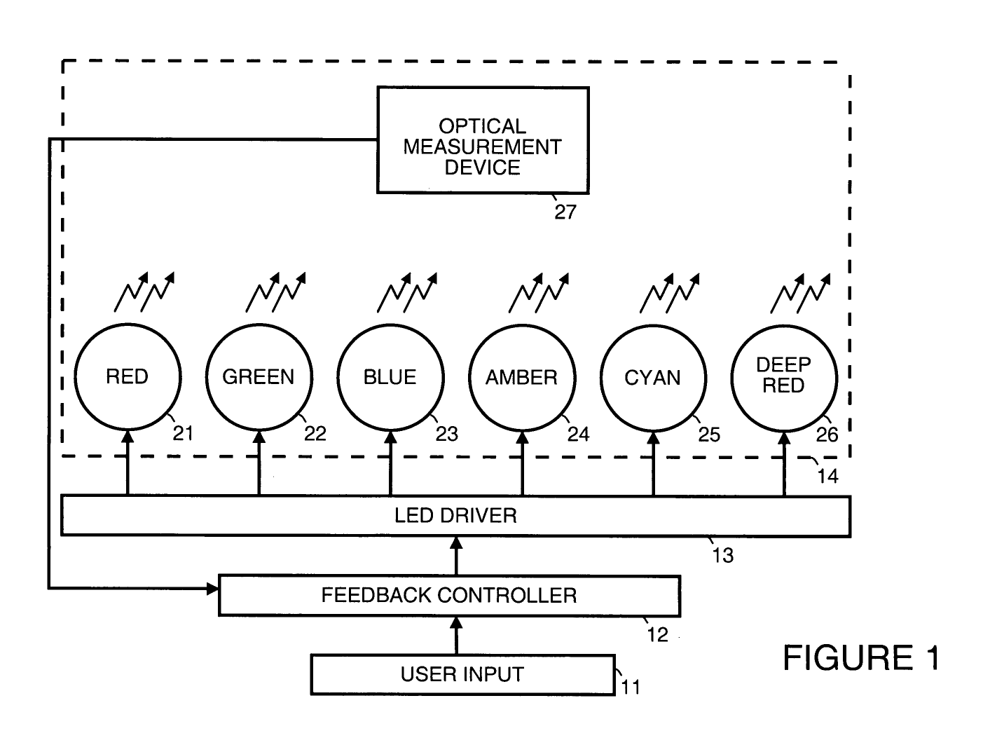

FIG. 1 is a simplified block diagram of a light source 14. The light source includes a red LED 21, a green LED 22, a blue LED 23, an amber LED 24, a cyan LED 25 and a deep red LED 26. An LED driver 13 controls forward current amplitude, and thus brightness for each of red LED 21, green LED 22, blue LED 23, amber LED 24, cyan LED 25 and deep red LED 26. Alternatively, when pulse width modulation is used, LED driver 13 controls signal duty cycle, and thus brightness for each of red LED 21, green LED 22, blue LED 23, amber LED 24, cyan LED 25 and deep red LED 26.

An optical measurement device 27 measures the spectrum of light generated by red LED 21, green LED 22, blue LED 23, amber LED 24, cyan LED 25 and deep red LED 26. Optical measurement device 27 provides feedback on the spectrum of light generated by red LED 21, green LED 22, blue LED 23, amber LED 24, cyan LED 25 and deep red LED 26 to a feedback controller 12. Feedback controller 12 controls LED driver 13 so that the spectrum of light generated by red LED 21, green LED 22, blue LED 23, amber LED 24, cyan LED 25 and deep red LED 26 matches a spectrum of light requested by user input 11. For example, a desired spectral power distribution curve for the requested spectrum of light gives a white color with color temperature that lies close to the black body curve.

For example, in order to match the SPD of sunlight, optical measurement device 27 measures light intensity at a broad spectrum that includes all the light generated by red LED 21, green LED 22, blue LED 23, amber LED 24, cyan LED 25 and deep red LED 26. For example, to accomplish this, optical measurement device 27 is implemented using a spectrometer or by multiple optical sensors that have spectral responses at different wavelength ranges. For example, optical measurement device 27 is implemented by the combination of a photosensor with a red color filter, a photosensor with a green color filter, a photosensor with a blue color filter, a photosensor with an amber color filter, a photosensor with a cyan color filter and a photosensor with a deep red color filter.

The capability of matching a broad spectrum of color allows optical measurement device 27 to control light source 14 to match the SPD of a target spectrum. Matching the target spectrum gives light source 14 the flexibility to generate different metamers of the same color. Metamers are colors that have different SPDs but the same visual appearance or tristimulus values.

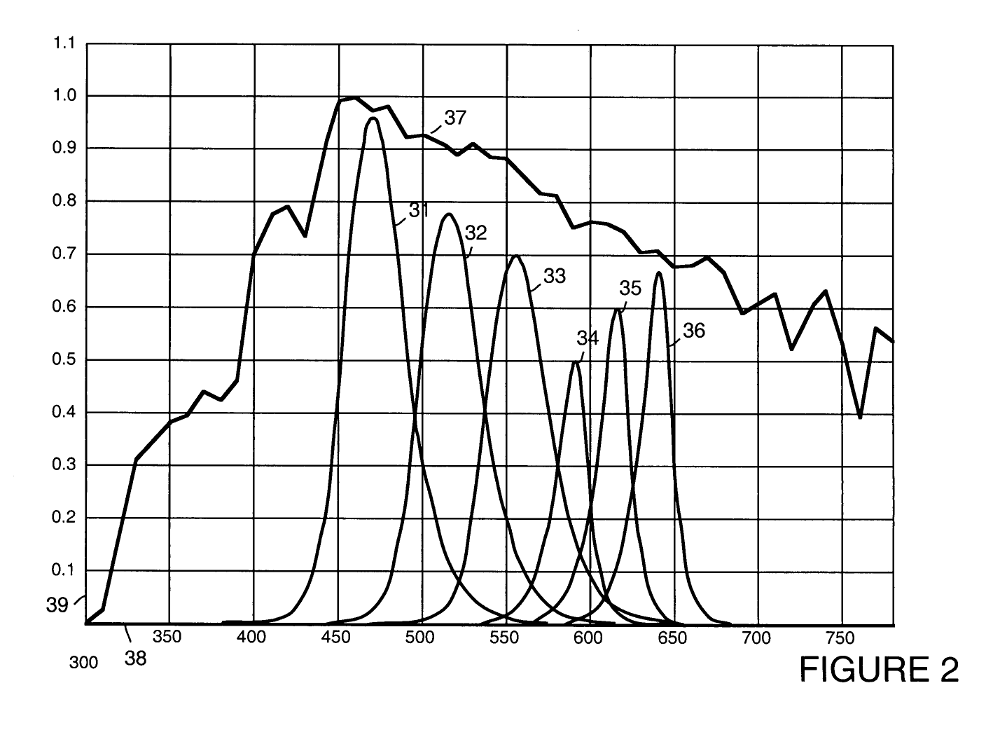

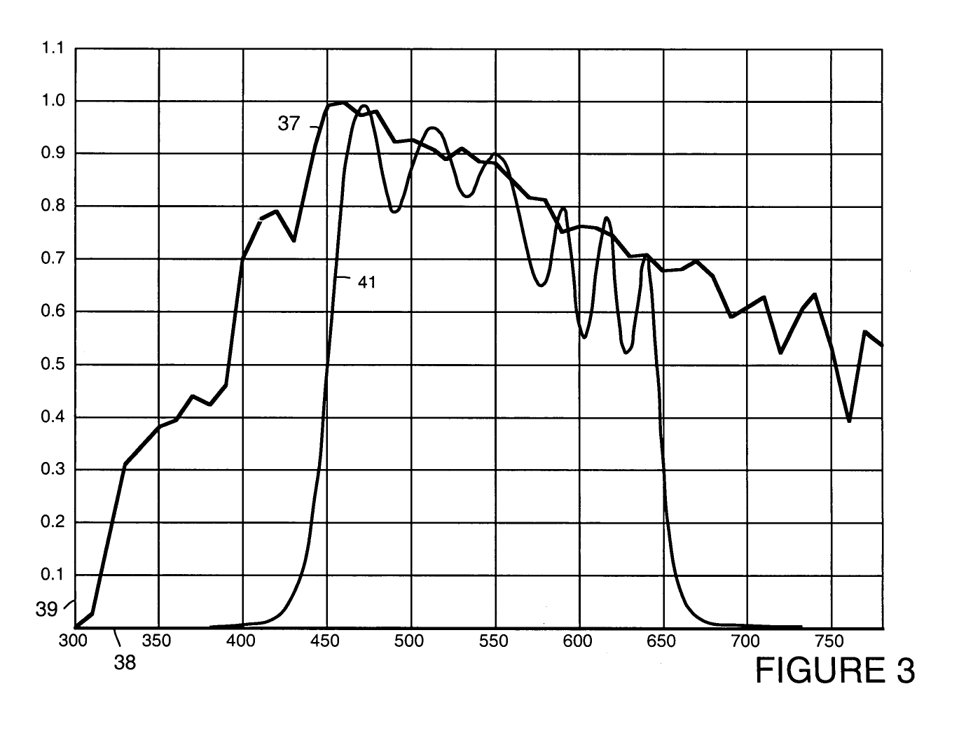

FIG. 2 and FIG. 3 illustrate how light source 14 can be used to generate light with an SPD curve that represents sunlight. In FIG. 2, an axis 38 represents wavelength in nanometers. An axis 39 represents normalized relative power. A trace 37 represents an SPD curve for CIE standard illuminant D65. A trace 31 represents an individual SPD curve for blue LED 23. A trace 32 represents an individual SPD curve for cyan LED 25. A trace 33 represents an individual SPD curve for green LED 22. A trace 34 represents an individual SPD curve for amber LED 24. A trace 35 represents an individual SPD curve for red LED 21. A trace 36 represents an individual SPD curve for deep red LED 26.

In FIG. 3, axis 38 represents wavelength in nanometers. Axis 39 represents normalized relative power. Trace 37 represents an SPD curve for CIE standard illuminant D65. A trace 41 represents a combined SPD curve for blue LED 23, cyan LED 25, green LED 22, amber LED 24, red LED 21 and deep red LED 26.

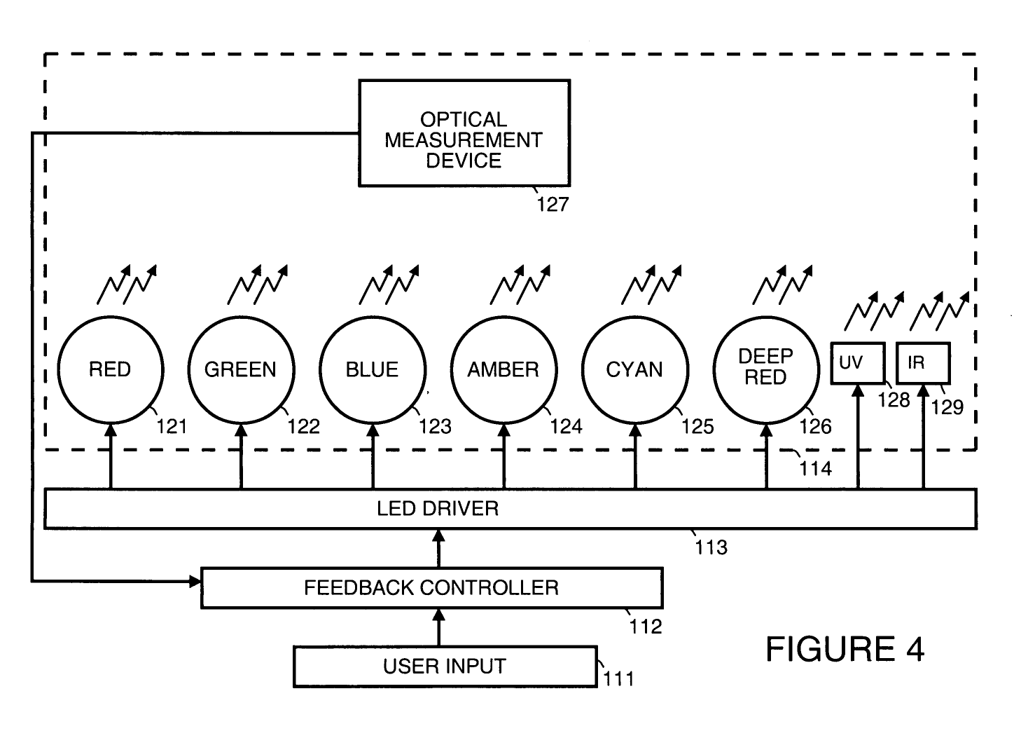

Embodiments of the invention can also extend the light spectrum generated by a light source to include non-visible spectral range. For example, both IR and UV light emitters can be added to the LED light source to produce a particular SPD curve for application that requires infrared (IR) and ultraviolet (UV) components. This is illustrated by FIG. 4.

FIG. 4 is a simplified block diagram of a light source 114. The light source includes a red LED 121, a green LED 122, a blue LED 123, an amber LED 124, a cyan LED 125, a deep red LED 126, a UV light emitter 128 and an IR light emitter 129. For example, UV light emitter 128 is a UV LED; and, IR light emitter 129 is an IR LED. An LED driver 113 controls forward current amplitude or signal duty cycle, and thus brightness for each of red LED 121, green LED 122, blue LED 123, amber LED 124, cyan LED 125, deep red LED 126, UV light emitter 128 and IR light emitter 129.

An optical measurement device 127 measures the spectrum of light generated by red LED 121, green LED 122, blue LED 123, amber LED 124, cyan LED 125, deep red LED 126, UV light emitter 128 and IR light emitter 129. Optical measurement device 127 provides feedback on the spectrum of light generated by red LED 121, green LED 122, blue LED 123, amber LED 124, cyan LED 125, deep red LED 126, UV light emitter 128 and IR light emitter 129 to a feedback controller 112. Feedback controller 112 controls LED driver 113 so that the spectrum of light generated by red LED 121, green LED 122, blue LED 123, amber LED 124, cyan LED 125, deep red LED 126, UV light emitter 128 and IR light emitter 129 matches a spectrum of light requested by user input

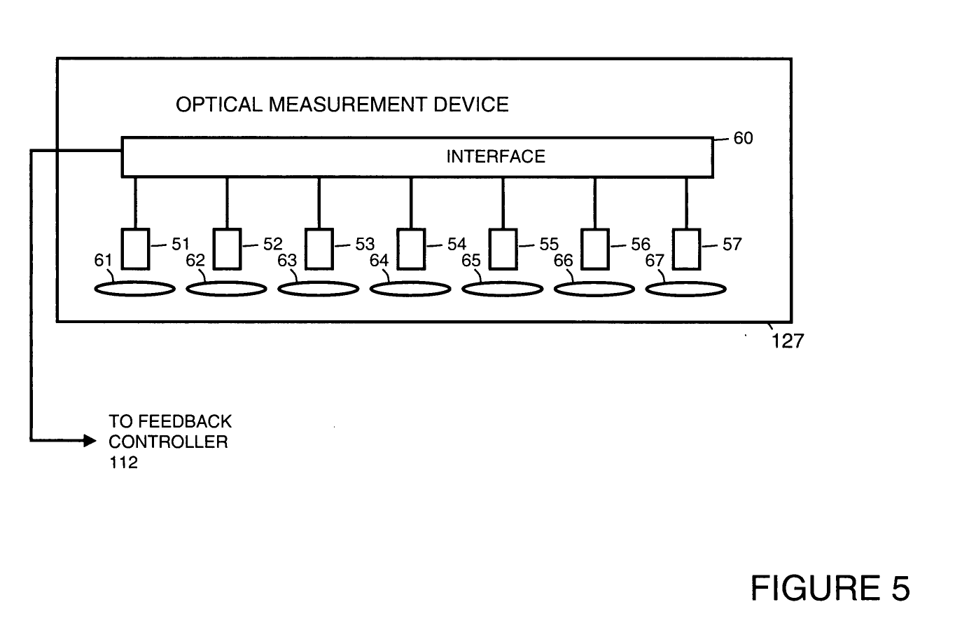

For example, in order to match the SPD of sunlight, optical measurement device 127 measures light intensity at a broad spectrum that includes all the light generated by red LED 121, green LED 122, blue LED 123, amber LED 124, cyan LED 125, deep red LED 126, UV light emitter 128 and IR light emitter 129. For example, to accomplish this, optical measurement device 127 is implemented by a spectrometer. Alternatively, optical measurement device 127 is implemented by a combination of optical sensors. This is illustrated by FIG. 5.

FIG. 5 shows optical measurement device implemented by a combination of optical sensors that have spectral responses at different wavelength ranges. A red color optical sensor is implemented by a red color filter 61 and a photosensor 51. A red color filter only allows red component of light generated by a light source to pass through. A green color optical sensor is implemented by a green color filter 62 and a photosensor 52. A blue color optical sensor is implemented by a blue color filter 63 and a photosensor 53. An amber color optical sensor is implemented by an amber color filter 64 and a photosensor 54. A cyan color optical sensor is implemented by a cyan color filter 65 and a photosensor 55. A deep red color optical sensor is implemented by a deep red color filter 66 and a photosensor 56. A UV optical sensor is implemented by a UV filter 67 and a photosensor 57. An IR optical sensor is implemented by an IR filter 68 and a photosensor 58. An interface 60, that includes, for example, analog-to-digital converters (ADCs), generates feedback signals sent to feedback controller 112.

While light sources with six and eight different spectrals are described above, the spectrals chosen and number of spectrals used are meant to be illustrative only. The particular spectrals used and the number of different spectrals is determined by the desired light spectrum and the accuracy desired for a particular generated SPD as compared to the target SPD. In general, increasing the number of spectrals allows better SPD matching with fewer gaps.

The foregoing discussion discloses and describes merely exemplary methods and embodiments of the present invention. As will be understood by those familiar with the art, the invention may be embodied in other specific forms without departing from the spirit or essential characteristics thereof. Accordingly, the disclosure of the present invention is intended to be illustrative, but not limiting, of the scope of the invention, which is set forth in the following claims.

We claim:

1. A method to generate light in accordance with a desired spectral power distribution curve, comprising:
generating a spectrum of light with a plurality of different light sources;
measuring, by an optical measurement device, the spectrum of light generated by the plurality of different light sources, the optical measurement device being able to detect light within the entire spectrum of light generated by the plurality of different light sources; and,
using the measured spectrum of light as feedback to vary the spectrum of light generated with the plurality of different light sources to approximate the desired spectral power distribution curve.

2. A method as in claim 1 wherein the desired spectral power distribution curve is a CIE standard illuminant.

3. A method as in claim 1 wherein the plurality of different light sources includes a red light emitting diode (LED), a green LED, a blue LED, an amber LED, a cyan LED and a deep red LED.

4. A method as in claim 1 wherein the plurality of different light sources includes a red light emitting diode (LED), a green LED, a blue LED, an amber LED, a cyan LED and a deep red LED a ultraviolet light emitter and an infrared light emitter.

5. A method as in claim 1 wherein the optical measurement device is a spectrometer.

6. A method as in claim 1 wherein the optical measurement device includes a plurality of optical sensors that have spectral responses at different wavelength ranges.

7. A method as in claim 1 wherein the desired spectral power distribution curve gives a white color with color temperature that lies close to the black body curve.

8. A light source, comprising:
a plurality of different light sources able to generate a spectrum of light in accordance with a desired spectral power distribution curve;
an optical measurement device, the optical measurement device measuring the spectrum of light generated by the plurality of different light sources; and,
feedback control for the plurality of different light sources, the feedback control using information from the optical measurement device about the measured spectrum of light to vary the spectrum of light generated by the plurality of different light sources to approximate the desired spectral power distribution curve.

9. A light source as in claim 8 wherein the desired spectral power distribution curve is a CIE standard illuminant.

10. A light source as in claim 8 wherein the plurality of different light sources includes a red light emitting diode (LED), a green LED, a blue LED, an amber LED, a cyan LED and a deep red LED.

11. A light source as in claim 8 wherein the plurality of different light sources includes a red light emitting diode (LED), a green LED, a blue LED, an amber LED, a cyan LED and a deep red LED a ultraviolet light emitter and an infrared light emitter.

12. A light source as in claim 8 wherein the optical measurement device is a spectrometer.

13. A light source as in claim 8 wherein the optical measurement device includes a plurality of optical sensors that have spectral responses at different wavelength ranges.

14. A light source as in claim 8 wherein the optical measurement device includes a plurality of optical sensors that have spectral responses at different wavelength ranges, each optical sensor including a filter and a photosensor.

15. A light source, comprising:
a plurality of different light means for generating a spectrum of light in accordance with a desired spectral power distribution curve;
an optical measurement means for measuring the spectrum of light generated by the plurality of different light means; and,
feedback control means for using information from the optical measurement means about the measured spectrum of light to vary the spectrum of light generated by the plurality of different light means to approximate the desired spectral power distribution curve.

16. A light source as in claim 15 wherein the desired spectral power distribution curve is a CIE standard illuminant.

17. A light source as in claim 15 wherein the plurality of different light means includes a red light emitting diode (LED), a green LED, a blue LED, an amber LED, a cyan LED and a deep red LED.

18. A light source as in claim 15 wherein the plurality of different light means includes a red light emitting diode (LED), a green LED, a blue LED, an amber LED, a cyan LED and a deep red LED a ultraviolet light emitter and an infrared light emitter.

19. A light source as in claim 15 wherein the optical measurement means includes a plurality of optical sensors that have spectral responses at different wavelength ranges.

20. A light source as in claim 15 wherein the optical measurement means includes a plurality of optical sensors that have spectral responses at different wavelength ranges, each optical sensor including a filter and a photosensor.
